(19) United States
(12) Patent Application Publication
(10) Pub. No.: US 2024/0150002 A1
(43) Pub. Date: May 9, 2024

(54) SEGMENTED SPANWISE BEAM FOR ENHANCED CENTER WING BOX ACCESS

(71) Applicant: The Boeing Company, Chicago, IL (US)

(72) Inventors: Ian Forrest Whitfield, Seattle, WA (US); Erik Alan Phillips, Kirkland, WA (US)

(73) Assignee: The Boeing Company, Chicago, IL (US)

(21) Appl. No.: 18/053,983

(22) Filed: Nov. 9, 2022

(51) Int. Cl. B64C 3/20; B64C 3/18

(52) U.S. Cl. CPC B64C 3/20; B64C 3/185

(57) ABSTRACT

An aircraft, a center wing box assembly for an aircraft, and a spanwise beam section for a center wing box assembly that includes a segmented structural configuration with an optimized access hole to accommodate user access into an interior space of the center wing box for purposes of assembly and maintenance. The center wing box assembly includes a first spanwise beam section, a second spanwise beam section, spaced from the first spanwise beam section, and a plurality of chord members serving as load-bearing structural reinforcement members for the first spanwise beam section and the second spanwise beam section. The chord members extend across the space between the first spanwise beam section and the second spanwise beam section to connect the first spanwise beam section and the second spanwise beam section in a manner which defines an access hole at the interior space.

### FIELD

One or more embodiments relate generally to an aircraft, a center wing box assembly for an aircraft, and a spanwise beam section for a center wing box assembly that includes a segmented structural configuration with an optimized access hole to accommodate user access into an interior space of the center wing box for purposes of assembly and maintenance.

### BACKGROUND

A center wing box of an aircraft is a structural component which is operable to provide support and rigidity to the wings of the aircraft. The center wing box is positioned between and connected to the wings and has a structural configuration and design that varies depending on the size and function of the aircraft. To accommodate access to an interior space of the center wing box for purposes of assembly and maintenance, an access hole, port, or door is provided and defined by a cutout in a continuous web of material of the center wing box.

The structural configuration of the access hole, in particular, the height and vertical position of the access hole are constrained by the presence of peak strains at the corners of the cutout in the continuous web of material. Such peak strain which are a function of the strain gradient between the upper panel, the lower panel, the laminate composition, and the corner geometry. For attachment of carbon fiber span-wise beams, the access holes must leave web material above and below the access hole in order to limit peak strains near the corners of the access hole. Thus, the size and orientation of the access hole makes user access for maintenance work very ergonomically challenging. These difficulties present a risk of workplace injury and damage to the center wing box.

### SUMMARY

In one or more example embodiments, an aircraft may include one or more of the following: a center wing box assembly including a forward spar member, a rear spar member, an upper panel member, and a lower panel member that defines an interior space; and one or more spanwise beam sections arranged in the interior space, each spanwise beam section in the one or more spanwise beam sections having a segmented structural configuration that includes spaced apart spanwise beam web sections and a plurality of chord members serving as load-bearing structural reinforcement members for the spanwise beam web sections and operable to connect the spanwise beam web sections in a manner which defines an access hole at the interior space between the spanwise beam web sections.

In one or more example embodiments, an aircraft may include one or more of the following: a center wing box assembly including a forward spar member, a rear spar member, an upper panel member, and a lower panel member that defines an interior space; and one or more spanwise beam sections arranged in the interior space, each spanwise beam section in the one or more spanwise beam sections having a segmented structural configuration that includes a first spanwise beam section, a second spanwise beam section spaced from the first spanwise beam section; and a plurality of chord members serving as load-bearing structural reinforcement members to connect the first spanwise beam section and the second spanwise beam section in a manner which defines an access hole at the interior space between the spanwise beam sections, the chord members including: first chord members extending in a lateral direction for connection to a planar surface at upper regions and lower regions of the first spanwise beam section and the second spanwise beam section, and second chord members extending between and connected to the first chord members at a region adjacent to the access hole.

In one or more example embodiments, a center wing box assembly for an aircraft may include one or more of the following: a forward spar member, a rear spar member, an upper panel member, and a lower panel member that defines an interior space; and one or more spanwise beam sections arranged in the interior space, each spanwise beam section in the one or more spanwise beam sections having a segmented structural configuration that includes spaced apart spanwise beam web sections and a plurality of chord members serving as load-bearing structural reinforcement members for the spanwise beam web sections and operable to connect the spanwise beam web sections in a manner which defines an access hole at the interior space between the spanwise beam web sections.

In one or more example embodiments, a center wing box assembly for an aircraft may include one or more of the following: a forward spar member, a rear spar member, an upper panel member, and a lower panel member that defines an interior space; and one or more spanwise beam sections arranged in the interior space, each spanwise beam section in the one or more spanwise beam sections having a segmented structural configuration that includes a first spanwise beam section, a second spanwise beam section spaced from the first spanwise beam section; and a plurality of chord members serving as load-bearing structural reinforcement members to connect the first spanwise beam section and the second spanwise beam section in a manner which defines an access hole at the interior space between the spanwise beam sections, the chord members including: first chord members extending in a lateral direction for connection to a planar surface at upper regions and lower regions of the first spanwise beam section and the second spanwise beam section, and second chord members extending between and connected to the first chord members at a region adjacent to the access hole.

In one or more example embodiments, a spanwise beam section for a center wing box assembly of an aircraft may include one or more of the following: a first spanwise beam web section; a second spanwise beam web section spaced from the first spanwise beam web section; and a plurality of chord members serving as load-bearing structural reinforcement members for the first spanwise beam web section and the second spanwise beam web section, the chord members extending across the space between the first spanwise beam web section and the second spanwise beam web section to connect the first spanwise beam section and the second spanwise beam section in a manner which defines an access hole at the interior space.

In one or more example embodiments, a spanwise beam section for a center wing box assembly of an aircraft may include one or more of the following: one or more spanwise beam sections arranged in the interior space, each spanwise beam section in the one or more spanwise beam sections having a segmented structural configuration that includes a first spanwise beam section, a second spanwise beam section spaced from the first spanwise beam section; and a plurality of chord members serving as load-bearing structural reinforcement members to connect the first spanwise beam section and the second spanwise beam section in a manner which defines an access hole at the interior space between the spanwise beam sections, the chord members including: first chord members extending in a lateral direction for connection to a planar surface at upper regions and lower regions of the first spanwise beam section and the second spanwise beam section, and second chord members extending between and connected to the first chord members at a region adjacent to the access hole.

The features, functions, and advantages that have been discussed can be achieved independently in various embodiments or may be combined in yet other embodiments further details of which can be seen with reference to the following description and drawings.

### DRAWINGS

The various advantages of the examples of the present disclosure will become apparent to one skilled in the art by reading the following specification and appended claims, and by referencing the following drawings, in which:

FIG. 1 illustrates a perspective view of an aircraft having a center wing box assembly.

FIG. 2 illustrates a front view of an advantageous embodiment of a spanwise beam for the center wing box assembly of FIG. 6.

FIG. 3 illustrates a perspective view of the spanwise beam of FIG. 2.

FIG. 4 illustrates a side view of the spanwise beam of FIG. 2.

FIG. 5 illustrates a front view of an advantageous embodiment of a spanwise beam for the center wing box assembly of FIG. 6.

FIG. 6 illustrates a perspective view of a center wing box assembly for the aircraft of FIG. 1.

### DESCRIPTION

An aircraft, a center wing box assembly for an aircraft, and a spanwise beam section for a center wing box assembly that includes a segmented structural configuration with an optimized access hole to accommodate user access into an interior space of the center wing box for purposes of assembly and maintenance. The spanwise beam section addresses the severe ergonomic challenges associated with an assembly and/or maintenance worker gaining access to the interior space of the center wing box assembly through an access hole. Such ergonomic challenges present risks of workplace injury and/or damage to the aircraft during assembly and maintenance.

This disclosure provides a spanwise beam section having a segmented structural configuration that includes spaced-apart spanwise beam web sections that help define an access hole having an increased overall size that alleviates the ergonomic challenges while reducing risk of workplace injuries and damage to the center wing box. In particular, the access hole comprises a substantially rectangular configuration that has an overall size (area) that is greater than the overall size of traditional or existing access hole designs due to an increase in the height of the access hole relative to a maximum height of traditional access holes. The increased height provides an ergonomic design that facilitates ease in access into an interior space of the center wing box for purposes of assembly and maintenance.

The segmented spanwise beam section structural configuration also reduces confined space work and total assembly hours by eliminating the need for fastening the spanwise beam web to the chord member in a region where the web is removed as well as eliminating horizontal stiffeners and associated joints that are typically used to frame the top and bottom of traditional or existing access holes.

The segmented spanwise beam section structural configuration also eliminates a need fora continuous web to fabricate the spanwise beam section. Due to the reduction in material web needed to fabricate the spanwise beam section, the overall weight of the segmented spanwise beam section is reduced and the manufacturing costs are reduced.

The segmented spanwise beam section structural configuration further eliminates stress concentration(s) that produces large peak strains at the corners of cutouts of a continuous web in traditional or existing center wing box configurations. This detail is, in turn, replaced by additional load transfer from each spanwise beam web section to the chords and other nearby shear structures such as spars, stringers, over-wing beams, and keel under-wing webs.

The segmented spanwise beam section structural configuration also defines an access hole that is centered on the fuselage centerline of the aircraft to take advantage of the relatively low vertical shear loads in this region and placing supporting structure (e.g., keel, over-wing beams) at the corners of the access hole to provide alternate load paths for the vertical shear loads while restraining bending of the spanwise beam chords.

The segmented spanwise beam section structural configuration may be implemented in future center wing box designs, and/or, retroactively applied to existing center wing box designs.

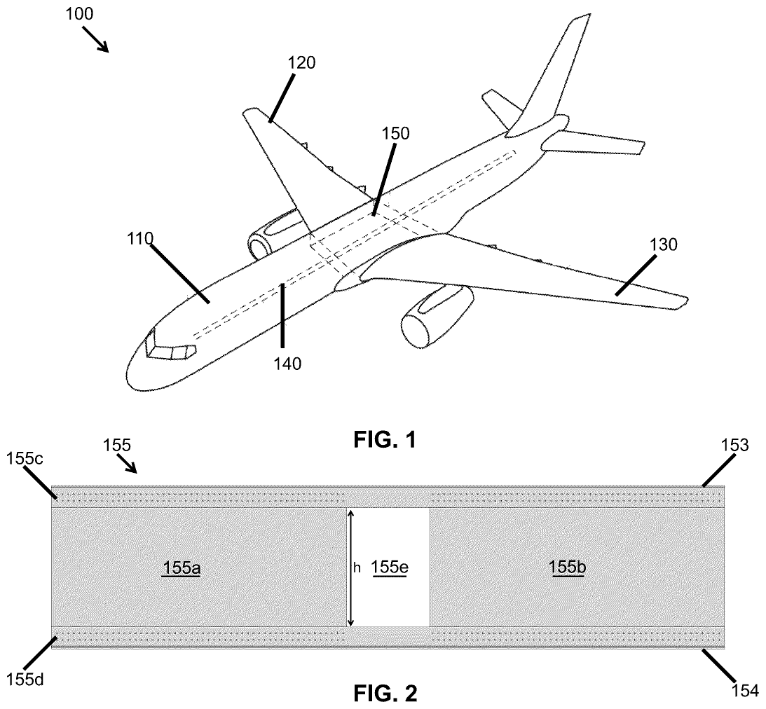

In the illustrated exemplary embodiment of FIG. 1, an aircraft 100 includes a fuselage 110, wings 120, 130 that are attached to a center wing box assembly 150 arranged within the fuselage 110. The center wing box assembly 150, which is operable to provide continuity to the wings 120, 130 through the fuselage 110, is also operable to absorb various stresses during the operation of aircraft 100. The center wing box assembly 150 is attached to one or more keel beams 140 which are also arranged in the fuselage 110.

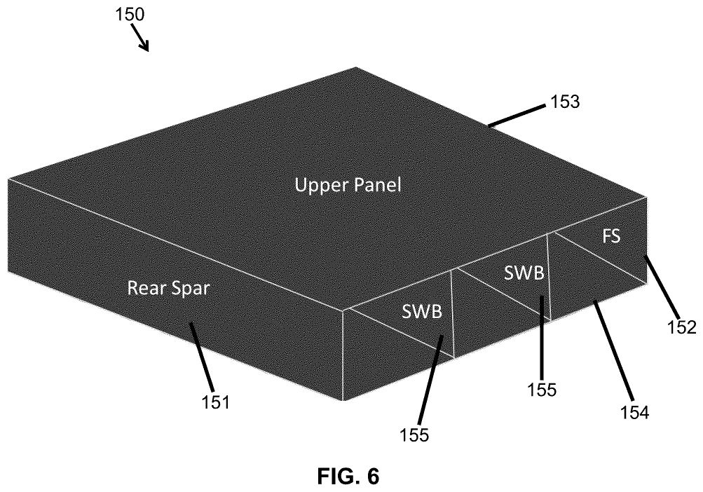

In the illustrated exemplary embodiment of FIG. 6, the center wing box assembly 150 includes a rear spar member 151, a forward spar member 152, an upper panel member 153, and a lower panel member 154 that defines an interior space that includes one or more compartments. The center wing box assembly 150 further includes one or more spanwise beam sections 155 that are arranged in the interior space to define the one or more compartments.

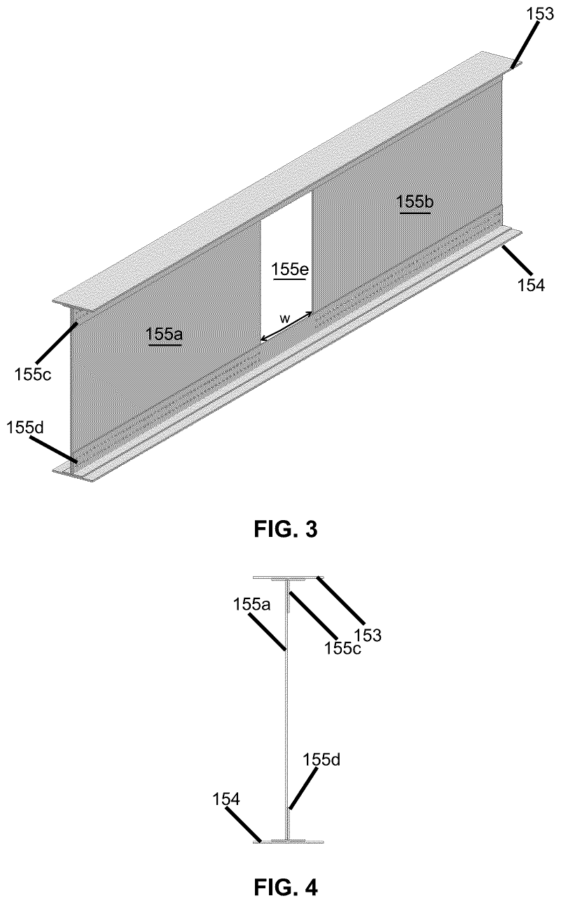

In the illustrated exemplary embodiment of FIGS. 2 to 4, each spanwise beam member 155 has a segmented structural configuration that comprises a first spanwise beam web section 155a and a second spanwise beam web section 155b that is spaced from the first spanwise beam web section 155a. The first spanwise beam web section 155a and the second spanwise beam web section 155b are operable to carry structural loads of the aircraft 100. An exemplary material for fabricating the first spanwise beam web section 155a and the second spanwise beam web section 155b includes, but is not limited to, carbon fiber. Thus, this disclosure contemplates fabricating the first spanwise beam web section 155a and the second spanwise beam web section 155b using any suitable material that falls within the spirit and scope of the principles of this disclosure set forth, illustrated, and/or described herein. In the illustrated exemplary embodiment, the first spanwise beam web section 155a and the second spanwise beam web section 155b are arranged symmetrically relative to the access hole 155e. Embodiments, however, are not limited thereto. Thus, this disclosure contemplates the first spanwise beam web section 155a and the second spanwise beam web section 155b being arranged in any suitable manner that falls within the spirit and scope of the principles of this disclosure set forth, illustrated, and/or described herein. For example, the first spanwise beam web section 155a and the second spanwise beam web section 155b may be arranged asymmetrically relative to the access hole 155e.

A plurality of chord members is operable to serve as load-bearing structural reinforcement members for the first spanwise beam web section 155a and the second spanwise beam web section 155b. The plurality of chord members comprises an upper chord member 155c and a lower chord member 155d that is spaced from the upper chord member 155c. The center wing box assembly 150 also includes upper panel 153 and lower panel 154.

The upper chord member 155c and the lower chord member 155d extend across the space between the first spanwise beam web section 155a and the second spanwise beam web section 155b to connect the first spanwise beam web section 155a and the second spanwise beam web section 155b in a manner which defines an access hole 155e at the interior space. The upper chord member 155c extends in a lateral direction across for connection to an upper planar surface of the first spanwise beam web section 155a and an upper planar surface of the second spanwise beam web section 155b. The lower chord member 155d extends in a lateral direction across for connection to a lower planar surface of the first spanwise beam web section 155a and a lower planar surface of the second spanwise beam web section 155b.

The access hole 155e is defined by an inner peripheral edge of the first spanwise beam web section 155a, an inner peripheral edge of the second spanwise beam web section 155b, a lower peripheral edge of the upper chord member 155c, and an upper peripheral edge of the lower chord member 155d. The access hole 155e, in an exemplary embodiment includes, but is not limited to, a polygonal geometric shape/cross-section. In the illustrated exemplary embodiment, the polygonal geometric shape/cross-section comprises a rectangle. Thus, this disclosure contemplates the access hole 155e having any suitable geometric configuration that falls within the spirit and scope of the principles of this disclosure set forth, illustrated, and/or described herein. The access hole 155e has an overall size (area) that is greater than the overall size of traditional or existing access hole designs due to an increase in the height of the access hole 155e relative to a maximum height of traditional access holes. The increased height of the access hole 155e provides an ergonomic design that facilitates ease in access into the interior space of the center wing box assembly 150 for purposes of assembly and maintenance.

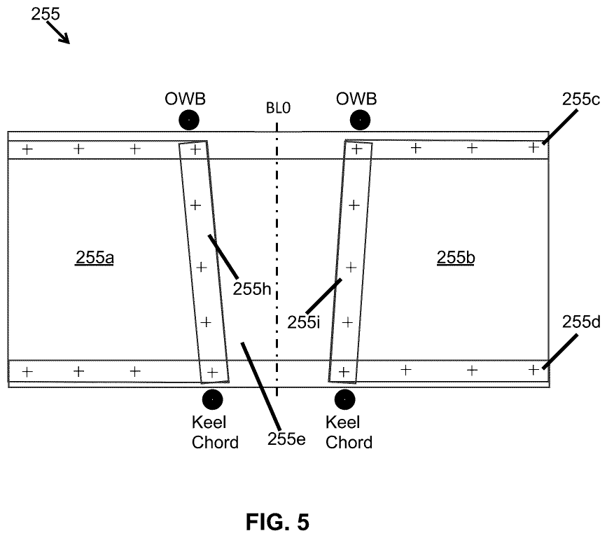

In the illustrated exemplary embodiment of FIG. 5, each spanwise beam member 255 has a segmented structural configuration that comprises a first spanwise beam web section 255a and a second spanwise beam web section 255b that is spaced from the first spanwise beam web section 255a. The first spanwise beam web section 255a and the second spanwise beam web section 255b are operable to carry structural loads of the aircraft 100. An exemplary material for fabricating the first spanwise beam web section 255a and the second spanwise beam web section 255b includes, but is not limited to, carbon fiber. Thus, this disclosure contemplates fabricating the first spanwise beam web section 255a and the second spanwise beam web section 255b using any suitable material that falls within the spirit and scope of the principles of this disclosure set forth, illustrated, and/or described herein. In the illustrated exemplary embodiment, the first spanwise beam web section 255a and the second spanwise beam web section 255b are arranged symmetrically relative to the access hole 255e. Embodiments, however, are not limited thereto. Thus, this disclosure contemplates the first spanwise beam web section 255a and the second spanwise beam web section 255b being arranged in any suitable manner that falls within the spirit and scope of the principles of this disclosure set forth, illustrated, and/or described herein. For example, the first spanwise beam web section 255a and the second spanwise beam web section 255b may be arranged asymmetrically relative to the access hole 255e.

A plurality of chord members is operable to serve as load-bearing structural reinforcement members for the first spanwise beam web section 255a and the second spanwise beam web section 255b. The plurality of chord members comprises first chord members extending in a lateral direction for connection to a planar surface at upper regions and lower regions of the first spanwise beam web section 255a and the second spanwise beam web section 255b, and second chord members extending between and connected to the first chord members 255c, 255d.

The first chord members comprise an upper chord member 255c and a lower chord member 255d that is spaced from the upper chord member 155c. The second chord members comprise a left chord member 255h and a right chord member 255i. The left chord member 255h extends at an angle relative to the upper chord member 255c and a lower chord member 255d for connection to a planar surface at an inner peripheral edge region of the first spanwise beam section 255a. The right chord member 255i extends at an angle relative to the upper chord member 255c and a lower chord member 255d for connection to a planar surface at an inner peripheral edge region of the second spanwise beam web section 255b. Supporting structure such as one or more over wing beam (OWB) members and keel chord members are arranged at the corners of the access hole 255e to provide alternate load paths for the vertical shear loads while restraining bending of the spanwise beam chords 255c, 255d, 255h, 255i.

The upper chord member 255c and the lower chord member 255d extend across the space between the first spanwise beam web section 255a and the second spanwise beam web section 255b to connect the first spanwise beam web section 255a and the second spanwise beam web section 255b in a manner which at least partially defines the access hole 255e at the interior space. The upper chord member 255c extends in a lateral direction across for connection to an upper planar surface of the first spanwise beam web section 255a and an upper planar surface of the second spanwise beam web section 255b. The lower chord member 255d extends in a lateral direction across for connection to a lower planar surface of the first spanwise beam web section 255a and a lower planar surface of the second spanwise beam web section 255b.

In accordance with one example embodiment, the access hole 255e is defined by an inner peripheral surface of the left chord member 255h, an inner peripheral surface of the right chord member 255i, a lower peripheral surface of the upper chord member 255c, and an upper peripheral surface of the lower chord member 255d. The left chord member 255h and the right chord member 255i are also operable as a structural reinforcement that enhances the overall structural integrity of the center wing box at the access hole 255e in a manner which eliminates or otherwise reduces stress concentrations at the access hole 255e.

The access hole 255e, in another exemplary embodiment includes, but is not limited to, a polygonal geometric shape/cross-section. In the illustrated exemplary embodiment, the polygonal geometric shape/cross-section comprises an isosceles trapezoid. Thus, this disclosure contemplates the access hole 255e having any suitable geometric configuration that falls within the spirit and scope of the principles of this disclosure set forth, illustrated, and/or described herein. The access hole 255e has an overall size (area) that is greater than the overall size of traditional or existing access hole designs due to an increase in the height of the access hole 255e relative to a maximum height of traditional access holes. The increased height of the access hole 255e provides an ergonomic design that facilitates ease in access into the interior space of the center wing box assembly for purposes of assembly and maintenance.

The terms “coupled,” “attached,” or “connected” used herein is to refer to any type of relationship, director indirect, between the components in question, and is to apply to electrical, mechanical, fluid, optical, electromagnetic, electromechanical or other connections. Additionally, the terms “first,” “second,” etc. are used herein only to facilitate discussion, and carry no particular temporal or chronological significance unless otherwise indicated. The terms “cause” or “causing” mean s to make, force, compel, direct, command, instruct, and/or enable an event or action to occur or at least be in a state where such event or action is to occur, either in a direct or indirect manner.

Those skilled in the art will appreciate from the foregoing description that the broad techniques of the one or more embodiments of the present disclosure is to be implemented in a variety of forms. Therefore, while the present disclosure describes matters in connection with particular embodiments thereof, the true scope of the embodiments of the present disclosure should not be so limited since other modifications will become apparent to the skilled practitioner upon a study of the drawings, specification, and following claims.

What is claimed is:

1. A center wing box assembly for an aircraft, the center wing box assembly comprising:
a forward spar member, a rear spar member, an upper panel member, and a lower panel member that defines an interior space; and
one or more spanwise beam sections arranged in the interior space, each spanwise beam section in the one or more spanwise beam sections having a segmented structural configuration that includes spaced apart spanwise beam web sections and a plurality of chord members serving as load-bearing structural reinforcement members for the spanwise beam web sections and operable to connect the spanwise beam web sections in a manner which defines an access hole at the interior space between the spanwise beam web sections.

2. The center wing box assembly of claim 1, wherein the plurality of chord members comprises an upper chord member extending in a lateral direction for connection to a planar surface at an upper region of the spanwise beam web sections.

3. The center wing box assembly of claim 2, wherein the plurality of chord members comprises a lower chord member, spaced from the upper chord member, extending in a lateral direction for connection to a planar surface at a lower region of the spanwise beam web sections.

4. The center wing box assembly of claim 3, wherein the access hole is defined by an inner peripheral edge of the spanwise beam web sections, a lower peripheral edge of the upper chord member, and an upper peripheral edge of the lower chord member.

5. The center wing box assembly of claim 1, wherein the spanwise beam web sections are arranged symmetrically relative to the access hole.

6. The center wing box assembly of claim 1, wherein the spanwise beam web sections are composed of a material web comprising carbon fiber.

7. An aircraft, comprising:
a center wing box assembly including:
a forward spar member, a rear spar member, an upper panel member, and a lower panel member that defines an interior space; and
one or more spanwise beam sections arranged in the interior space, each spanwise beam section in the one or more spanwise beam sections having a segmented structural configuration that includes spaced apart spanwise beam web sections and a plurality of chord members serving as load-bearing structural reinforcement members for the spanwise beam web sections and operable to connect the spanwise beam web sections in a manner which defines an access hole at the interior space between the spanwise beam web sections.

8. The aircraft of claim 7, wherein the plurality of chord members comprises an upper chord member extending in a lateral direction for connection to a planar surface at an upper region of the spanwise beam web sections.

9. The aircraft of claim 8, wherein the plurality of chord members comprises a lower chord member, spaced from the upper chord member, extending in a lateral direction for connection to a planar surface at a lower region of the spanwise beam web sections.

10. The aircraft of claim 9, wherein the access hole is defined by an inner peripheral edge of the spanwise beam web sections, a lower peripheral edge of the upper chord member, and an upper peripheral edge of the lower chord member.

11. The aircraft of claim 7, wherein the spanwise beam web sections are arranged symmetrically relative to the access hole.

12. The aircraft of claim 7, wherein the spanwise beam web sections are composed of a material web comprising carbon fiber.

13. A spanwise beam section for a center wing box assembly of an aircraft, the spanwise beam section comprising:
a first spanwise beam web section;
a second spanwise beam web section spaced from the first spanwise beam web section; and
a plurality of chord members serving as load-bearing structural reinforcement members for the first spanwise beam web section and the second spanwise beam web section, the chord members extending across the space between the first spanwise beam web section and the second spanwise beam web section to connect the first spanwise beam section and the second spanwise beam section in a manner which defines an access hole at an interior space.

14. The spanwise beam section of claim 13, wherein the plurality of chord members comprises an upper chord member extending in a lateral direction for connection to a planar surface of an upper region of the first spanwise beam web section 155a and an upper region of the second spanwise beam web section.

15. The spanwise beam section of claim 14, wherein the plurality of chord members comprises a lower chord member, spaced from the upper chord member and extending in a lateral direction for connection to a planar surface of a lower region of the first spanwise beam web section and a lower region of the second spanwise beam web section.

16. The spanwise beam section of claim 15, wherein the access hole is defined by the first spanwise beam web section, the second spanwise beam web section, the upper chord member, and the lower chord member.

17. The spanwise beam section of claim 16, wherein the access hole is defined by an inner peripheral edge of the first spanwise beam web section, an inner peripheral edge of the second spanwise beam web section, a lower peripheral edge of the upper chord member, and an upper peripheral edge of the lower chord member.

18. The spanwise beam section of claim 13, wherein the first spanwise beam web section and the second spanwise beam web section are arranged symmetrically relative to the access hole.

19. The spanwise beam section of claim 13, wherein the first spanwise beam web section is composed of a material web comprising carbon fiber.

20. The spanwise beam section of claim 13, wherein the second spanwise beam web section is composed of a material web comprising carbon fiber.
